(19) United States
(12) Patent Application Publication
(10) Pub. No.: US 2025/0195978 A1
(43) Pub. Date: Jun. 19, 2025

(54) TENNIS TRAINING APPARATUS, TENNIS TRAINING SIMULATION METHOD AND APPARATUS, ELECTRONIC DEVICE, AND STORAGE MEDIUM

(71) Applicant: Jun PENG, Changsha (CN)

(72) Inventor: Jun PENG, Changsha (CN)

(21) Appl. No.: 19/070,572

(22) Filed: Mar. 5, 2025

Related U.S. Application Data
(63) Continuation of application No. PCT/CN2023/106740, filed on Jul. 11, 2023.

(30) Foreign Application Priority Data
Sep. 7, 2022 (CN) 202211089911.7
May 4, 2023 (CN) 202310495353.2

(51) Int. Cl. A63B 69/38; A63B 24/00; A63B 47/02; A63B 69/40; A63B 71/06

(52) U.S. Cl. CPC A63B 69/38; A63B 24/0006; A63B 47/02; A63B 69/408; A63B 71/0622; A63B 2024/0015; A63B 2071/0638; A63B 2214/00; A63B 2230/62

(57) ABSTRACT

A tennis training apparatus, a tennis training simulation method and apparatus, an electronic device, and a storage medium are provided. The method includes: acquiring ball hitting parameters in a real court through a racket, and acquiring ball hitting images in the real court; calculating first trajectory parameters of a first motion trajectory of a target tennis ball in the real court according to the ball hitting parameters and the ball hitting images; calculating second trajectory parameters of the target tennis ball in a virtual court based on the first trajectory parameters, where a court of the target tennis ball includes the real court and the virtual court; and rendering, by using the second trajectory parameters, a second motion trajectory of the target tennis ball during motion in the virtual court, where a motion trajectory of the target tennis ball includes the first motion trajectory and the second motion trajectory.

### CROSS-REFERENCE TO THE RELATED APPLICATIONS

This application is a continuation application of International Application No. PCT/CN2023/106740, filed on Jul. 11, 2023, which is based upon and claims priority to Chinese Patent Applications No. 202211089911.7, filed on Sep. 7, 2022, and No. 202310495353.2, filed on May 4, 2023, the entire contents of which are incorporated herein by reference.

### TECHNICAL FIELD

The present disclosure relates to the technical field of automatic control, and in particular, to a tennis training apparatus, a tennis training simulation method and apparatus, an electronic device, and a storage medium.

### BACKGROUND

In daily tennis training, a large quantity of tennis balls are used. After training, the tennis balls are scattered in all corners of the training ground and need to be picked up by special staff. This work of picking up tennis balls is time-consuming and laborious. In addition, after the tennis balls are collected together, training personnel are also needed to throw the balls.

Playing tennis requires not only certain skills, but also a very professional venue. On the one hand, limited by venue and equipment factors, beginners need to pay a large cost for online training. On the other hand, due to the large student population, it is unrealistic for schools and other institutions to plan multiple tennis courts, making it hard to popularize tennis sport to all the people.

### SUMMARY

The present disclosure provides a tennis training apparatus, a tennis training simulation method and apparatus, an electronic device, and a storage medium.

According to an aspect of the present disclosure, a tennis training apparatus is provided, including: a support frame assembly; a ball collecting assembly adjacent to a side of the support frame assembly close to a ball serving side; a ball transmission assembly, where a ball inlet of the ball transmission assembly is connected with the ball collecting assembly; and an elastic ball feeding assembly connected with a ball outlet of the ball transmission assembly and capable of ejecting a tennis ball to a side away from the support frame assembly.

In some embodiments, the elastic ball feeding assembly includes a ball feeding shell, a rotating ball throwing arm, a rotating frame and a first driving part, where the rotating frame is mounted in the ball feeding shell, a middle portion of the rotating ball throwing arm is rotatably connected with the rotating frame, a ball throwing end of the rotating ball throwing arm is located on a side of the rotating frame facing away from the support frame assembly, the first driving part is fitted with a force application end of the rotating ball throwing arm, and the force application end is located on a side of the rotating frame away from the ball throwing end.

In some embodiments, the first driving part includes an electromagnetic coil, a ferromagnetic body and an elastic member, where the ferromagnetic body is fixed on the force application end, the electromagnetic coil is fixed on the ball feeding shell, a first end of the elastic member is connected to the force application end between the ferromagnetic body and the rotating frame, and a second end of the elastic member is connected with the ball feeding shell.

In some embodiments, the first driving part further includes an elasticity adjuster, where the elasticity adjuster includes an adjuster shell, a rotating shaft and an abutting block, the adjuster shell is connected with the ball feeding shell, the abutting block is fixedly connected with the rotating shaft, the rotating shaft is rotatably fixed on the adjuster shell, the abutting block abuts against the second end of the elastic member, and a distance from a circumferential outer wall of the abutting block to the rotating shaft varies.

In some embodiments, the ball throwing end is provided with a groove.

In some embodiments, the elastic ball feeding assembly further includes a ball storage box and a ball drop tube, where an upper end of the ball drop tube is communicated with the ball storage box, and a lower end of the ball drop tube is communicated with the ball feeding shell.

In some embodiments, an inner diameter of the ball drop tube is greater than an outer diameter of a tennis ball and less than twice the outer diameter of the tennis ball.

In some embodiments, the elastic ball feeding assembly further includes a first limiting part fixed on an inner wall of the ball feeding shell, the rotating ball throwing arm has a ball throwing state and a to-throw-ball state, in a case that the rotating ball throwing arm is in the ball throwing state, a distance between a lower end of the first limiting part and the rotating ball throwing arm is less than the outer diameter of the tennis ball, and in a case that the rotating ball throwing arm is in the to-throw-ball state, the distance between the lower end of the first limiting part and the rotating ball throwing arm is greater than the outer diameter of the tennis ball.

In some embodiments, the rotating ball throwing arm is provided with a ball drop point located between the ball throwing end and a rotary shaft of the rotating ball throwing arm, and the lower end of the first limiting part is located between the ball drop point and the ball throwing end.

In some embodiments, the elastic ball feeding assembly further includes a second limiting part located on the rotating ball throwing arm, in a case that the rotating ball throwing arm is in the ball throwing state, the second limiting part is at an avoidance position avoiding the lower end of the ball drop tube, and in a case that the rotating ball throwing arm is in the to-throw-ball state, the second limiting part is at a limiting position of the lower end of the ball drop tube.

In some embodiments, the second limiting part is a limiting arm having a first end connected with the rotating ball throwing arm, and a second extending away from the lower end of the ball drop tube.

In some embodiments, the elastic ball feeding assembly further includes a second driving part and a mounting base, the second driving part is fixed on the mounting base, the ball feeding shell is rotatably mounted on the mounting base, and the second driving part is capable of driving the mounting base to rotate.

In some embodiments, the second driving part includes a rotating motor and a first gear, the elastic ball feeding assembly further includes a second gear rotatably mounted on the mounting base, the ball feeding shell is fixed on the second gear, an output end of the rotating motor is connected with the first gear, and the first gear is meshed with the second gear.

In some embodiments, the ball transmission assembly includes a transmission shell and a driving wheel, an endless conveyor belt, a driven wheel and a plurality of ball blocking plates located in the transmission shell, the driving wheel and the driven wheel are located at two ends of the endless conveyor belt respectively, the plurality of ball blocking plates are disposed on an outer wall of the endless conveyor belt at intervals, a bottom portion of the transmission shell is provided with the ball inlet, a top portion of the transmission shell is provided with the ball outlet, the ball inlet of the transmission shell is connected with the ball collecting assembly, and the ball outlet of the transmission shell is connected with the elastic ball feeding assembly.

In some embodiments, the quantity of the ball inlet is two, and the two ball inlets are located on wall surfaces of the transmission shell on two sides of the endless conveyor belt respectively, and are staggered.

In some embodiments, the ball collecting assembly is fixed on the support frame assembly.

In some embodiments, the tennis training apparatus further includes a control assembly disposed on the support frame assembly.

According to another aspect of the present disclosure, a tennis training simulation method is provided, including: acquiring ball hitting parameters in a real court through a racket, and acquiring ball hitting images in the real court, where the tennis training apparatus according to the present disclosure is deployed in the real court; calculating first trajectory parameters of a first motion trajectory of a target tennis ball in the real court according to the ball hitting parameters and the ball hitting images; calculating second trajectory parameters of the target tennis ball in a virtual court based on the first trajectory parameters, where a court of the target tennis ball includes the real court and the virtual court; and rendering, by using the second trajectory parameters, a second motion trajectory of the target tennis ball during motion in the virtual court, where a motion trajectory of the target tennis ball includes the first motion trajectory and the second motion trajectory.

In some embodiments, the acquiring ball hitting parameters in a real court through a racket includes: acquiring a ball hitting speed in the real court through a speed sensor on the racket; acquiring a ball hitting angle in the real court through a direction sensor on the racket; acquiring a ball hitting height in the real court through a height sensor on the racket; acquiring a ball hitting force in the real court through a force sensor on the racket; and acquiring a racket wielding trajectory in the real court through a tracker on the racket; where the ball hitting parameters include: the ball hitting speed, the ball hitting angle, the ball hitting height, the ball hitting force and the ball wielding trajectory.

In some embodiments, the calculating first trajectory parameters of a first motion trajectory of a target tennis ball in the real court according to the ball hitting parameters and the ball hitting images includes: calculating first initial motion parameters of the target tennis ball by using the ball hitting parameters, where the first initial motion parameters include: a start point motion speed, a start point motion direction, and a start point height; obtaining an environmental resistance coefficient in the real court; calculating trajectory end point parameters of the first motion trajectory of the target tennis ball in the real court by using the first initial motion parameters and the environmental resistance coefficient, where the trajectory end point parameters include: an end point motion speed, an end point motion direction, and an end point height; and modifying the trajectory end point parameters of the first motion trajectory by using the ball hitting images.

In some embodiments, the calculating trajectory end point parameters of the first motion trajectory of the target tennis ball in the real court by using the first initial motion parameters and the environmental resistance coefficient includes: obtaining a first court length of the real court and obtaining a ball weight of the target tennis ball; and setting the first court length as a maximum horizontal length of the first motion trajectory of the target tennis ball in the real court, and calculating the trajectory end point parameters of the target tennis ball after the target tennis ball runs by the first court length by using the first initial motion parameters, the ball weight, and the environmental resistance coefficient.

In some embodiments, the calculating second trajectory parameters of the target tennis ball in a virtual court based on the first trajectory parameters includes: determining trajectory end point parameters of the first motion trajectory of the target tennis ball in the real court in the first trajectory parameters, where the trajectory end point parameters include: an end point motion speed, an end point motion direction, and an end point height; and configuring the trajectory end point parameters as second initial motion parameters of the target tennis ball in the virtual court; and calculating intermediate motion parameters and termination motion parameters of a simulated motion of the target tennis ball in a real scene by using the second initial motion parameters, and determining the intermediate motion parameters and the termination motion parameters as second trajectory parameters of the target tennis ball in the virtual court.

In some embodiments, the rendering, by using the second trajectory parameters, a second motion trajectory of the target tennis ball during motion in the virtual court includes: fitting a third motion trajectory of the target tennis ball on a world coordinate system by using the second trajectory parameters; obtaining a thumbnail coordinate system of the virtual court, and converting the third motion trajectory from the world coordinate system to the thumbnail coordinate system to obtain the second motion trajectory; and dynamically displaying the second motion trajectory on a virtual screen of the virtual court.

In some embodiments, after the rendering, by using the second trajectory parameters, a second motion trajectory of the target tennis ball during motion in the virtual court, the method further includes: calculating ball hitting action parameters of a ball hitting person according to the ball hitting parameters and the ball hitting images, where the ball hitting action parameters are configured to represent an action standard degree of the ball hitting person during ball hitting; and calculating motion quality parameters of the target tennis ball in the virtual court according to the ball hitting parameters and the ball hitting images, where the motion quality parameters are configured to represent a standard degree of a motion trajectory after the target tennis ball is hit by the ball hitting person.

In some embodiments, the calculating ball hitting action parameters of a ball hitting person according to the ball hitting parameters and the ball hitting images includes: parsing a plurality of motion limb joints from the ball hitting images; selecting several key limb joints from the plurality of motion limb joints, where the key limb joints are limb joints required to exert force during tennis training, and the key limb joints include: hands, elbows, shoulders, waists and feet; creating a dynamic 3D human body model by using the plurality of key limb joints, and calculating the ball hitting action parameters of the ball hitting person according to motion amplitudes of the dynamic 3D human body model; and modifying the ball hitting action parameters by using the ball hitting parameters.

In some embodiments, the calculating the ball hitting action parameters of the ball hitting person according to motion amplitudes of the dynamic 3D human body model includes: capturing the dynamic 3D human body model with a starting racket wielding time, an intermediate racket wielding time, and an ending racket wielding time; adding a coordinate position combination of the key limb joints in a preset coordinate system after the dynamic 3D human body model is captured, where the coordinate position combination includes coordinate positions of a corresponding key limb joint at the starting racket wielding time, the intermediate racket wielding time, and the ending racket wielding time; for each key limb joint, sequentially connecting all coordinate positions in the coordinate position combination according to a capturing time to generate a limb motion trajectory; calculating an action matching degree between the limb motion trajectory and a preset standard action trajectory; and determining the action matching degree as the ball hitting action parameters of the ball hitting person.

In some embodiments, the calculating motion quality parameters of the target tennis ball in the virtual court according to the ball hitting parameters and the ball hitting images includes: calculating first trajectory parameters of a first motion trajectory of a target tennis ball in the real court according to the ball hitting parameters and the ball hitting images; calculating the second trajectory parameters of the target tennis ball in the virtual court based on the first trajectory parameters; fitting, by using the second trajectory parameters, the second motion trajectory of the target tennis ball during motion in the virtual court; calculating a posture matching degree between the second motion trajectory and a preset standard motion trajectory, where motion postures of the preset standard motion trajectory include: a direction, a radian, a speed, a drop point, and a height; and determining the posture matching degree as the motion quality parameter of the target tennis ball in the virtual court.

According to another aspect of the present disclosure, a tennis training simulation apparatus is further provided, including: an acquisition module, configured to acquire ball hitting parameters in a real court through a racket, and acquire ball hitting images in the real court, where a tennis training apparatus is deployed in the real court, and includes: a ball blocking assembly; a ball collecting assembly adjacent to the ball blocking assembly and provided with a ball collecting port; and a ball feeding assembly, where the ball feeding assembly is located on a side of the ball collecting assembly away from the ball blocking assembly, conveys a collected tennis ball to the ball feeding assembly, and is provided with a ball outlet; a first calculation module, configured to calculate the first trajectory parameters of the first motion trajectory of the target tennis ball in the real court according to the ball hitting parameters and the ball hitting images; a second calculation module, configured to calculate second trajectory parameters of the target tennis ball in a virtual court based on the first trajectory parameters, where a court of the target tennis ball includes the real court and the virtual court; and a rendering module, configured to render, by using the second trajectory parameters, a second motion trajectory of the target tennis ball during motion in the virtual court, where a motion trajectory of the target tennis ball includes the first motion trajectory and the second motion trajectory.

According to another aspect of the present disclosure, a storage medium is further provided. The storage medium includes a stored program. The program, when executed, implements the foregoing method steps.

According to another aspect of the present disclosure, an electronic device is further provided, including a processor, a communications interface, a memory, and a communications bus, where the processor, the communications interface, and the memory communicate with each other through the communications bus; where the memory is configured to store a computer program; and the processor is configured to implement the foregoing method steps by executing the program stored in the memory.

In some embodiments, the support frame assembly achieves an effect of supporting the ball collecting assembly. After a practicer hits a tennis ball to the ball collecting assembly, the ball collecting assembly collects the ball and enters the ball transmission assembly, and the ball transmission assembly transmits the tennis ball to the elastic ball feeding assembly to feed the ball. In this way, the number of times the staff picks up and throws the ball can be reduced, which greatly reduces the workload of the staff in picking up and throwing the ball, thereby improving the experience of the practicers. This effectively solves the problem that during tennis training, not only manpower is wasted, but the experience of practicers is also affected.

In some embodiments, the first trajectory parameters of the target tennis ball during motion in the real court and the second trajectory parameters during motion in the virtual court are calculated, and the motion trajectory of the target tennis ball in the virtual court is rendered. The combination of the real court and the virtual court solves the venue limitations and addresses the technical problem that the sports venue cannot be expanded through the virtual court.

### BRIEF DESCRIPTION OF THE DRAWINGS

The accompanying drawings described herein are provided for further understanding of the present disclosure, and constitute a part of the present disclosure. Exemplary embodiments of the present disclosure and descriptions thereof are intended to explain the present disclosure, but do not constitute any inappropriate limitation to the present disclosure.

To describe the technical solutions in the embodiments of the present disclosure more clearly, the drawings required for the description of the embodiments are briefly introduced below. Apparently, those of ordinary skill in the art may further obtain other drawings based on these drawings without creative efforts.

FIG. 1 is a schematic diagram illustrating an overall structure of a tennis training apparatus according to embodiment 1 of the present disclosure;

FIG. 2 is a top view of the tennis training apparatus according to FIG. 1;

FIG. 3 is a sectional view taken along line A-A of a ball collecting assembly of the tennis training apparatus according to FIG. 2;

FIG. 4 is a schematic structural diagram of a ball transmission assembly of the tennis training apparatus according to FIG. 1;

FIG. 5 is schematic diagram along an A direction of the ball transmission assembly according to FIG. 4;

FIG. 6 is a schematic structural diagram of an elastic ball feeding assembly of the tennis training apparatus according to FIG. 1;

FIG. 7 an enlarged partial view of the elastic ball feeding assembly according to FIG. 6;

FIG. 8 is a partial structural diagram of a support frame assembly of the tennis training apparatus according to FIG. 1;

FIG. 9 is a schematic diagram illustrating an overall structure of a tennis training apparatus according to embodiment 2 of the present disclosure;

FIG. 10 is a schematic structural diagram illustrating cooperation of the support frame assembly and the ball collecting assembly of the tennis training apparatus according to FIG. 9;

FIG. 11 is a flowchart of a tennis training simulation method according to an embodiment of the present disclosure;

FIG. 12 is a structural diagram of a system according to an embodiment of the present disclosure;

FIG. 13 is an operational flowchart according to an embodiment of the present disclosure;

FIG. 14 is a structural block diagram of a tennis training simulation apparatus according to an embodiment of the present disclosure; and

FIG. 15 is a structural block diagram of an electronic device according to an embodiment of the present disclosure.

Reference numerals in the drawings are as follows:

10. support frame assembly; 20. ball collecting assembly; 21. high-speed camera; 22. projector; 30. ball transmission assembly; 31. transmission shell; 32. driving wheel; 33. endless conveyor belt; 34. driven wheel; 35. ball blocking plate; 40. elastic ball feeding assembly; 41. ball feeding shell; 42. rotating ball throwing arm; 43. rotating frame; 44. electromagnetic coil; 45. ferromagnetic body; 46. elastic member; 47. elasticity adjuster; 48. first limiting part; 49. second limiting part; 50. second driving part; 60. mounting base; 70. control assembly; 100. practicer; 200. tennis racket; 300. tennis ball; 14.1. drawing wire; 14.2. wire coiling wheel; 14.3. long shaft; 14.4. driven gear; 14.5. driving gear; 14.6. ball collecting slot folding motor; 14.7. ball inlet hard plate; 13. side net rotating shaft; 14. helical bevel gear A; 15. helical bevel gear B; 16. top net rotating shaft; 17. tubular motor; 18. external power line; 19. motor shaft and shaft sleeve; 50.1. side net frame; 50.2. side net frame elongated slot; 50.3. top net front beam; 50.4. top net front beam elongated slot; 50.5. sliding pin; 5. tennis training simulation apparatus; 51. acquisition module; 52. first calculation module; 54. second calculation module; 56. rendering module; 6. electronic device; 61. processor; 62. communications interface; and 63. memory.

### DETAILED DESCRIPTION OF THE EMBODIMENTS

To make persons skilled in the art better understand the solutions of the present disclosure, the following describes the technical solutions in the embodiments of the present disclosure with reference to the accompanying drawings in the embodiments of the present disclosure. Apparently, the described embodiments are merely some but not all of the embodiments of the present disclosure. All other embodiments obtained by those of ordinary skill in the art based on the embodiments of the present disclosure shall fall within the protection scope of the present disclosure. It should be noted that the embodiments in the present disclosure and features in the embodiments may be combined with each other in a non-conflicting manner.

It should be noted that the terms “first”, “second”, and so on in the specification and claims of the present disclosure and in the accompanying drawings are intended to distinguish between similar objects but do not necessarily indicate a specific order or sequence. It is to be understood that data used in such a way is exchangeable under proper conditions, so that the embodiments of the present disclosure described herein can be implemented in an order different from the order illustrated or described herein. Moreover, the terms “include”, “contain” and any other variants mean to cover the non-exclusive inclusion, for example, a process, method, product, or device that includes a list of steps or units is not necessarily limited to those expressly listed steps or units, but may include other steps or units not expressly listed or inherent to such a process, method, system, product, or device. In the case that there are no more limitations, an element defined by the statement “include a . . . ” does not exclude the presence of other same elements in the process, the method, the article or the device including the element.

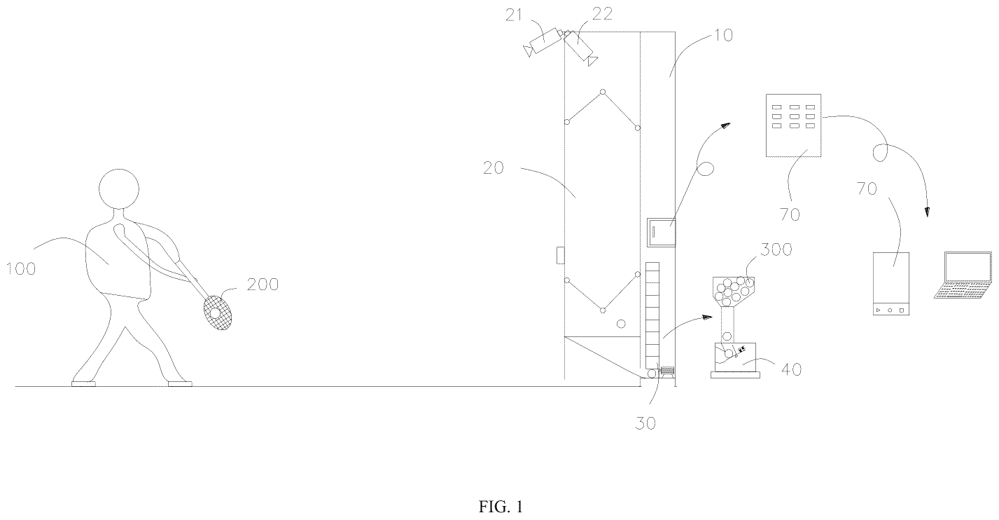

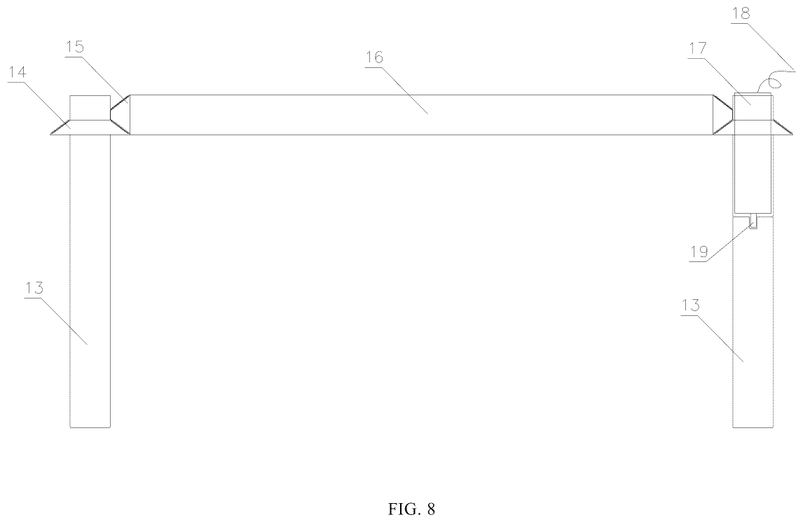

As shown in FIG. 1 to FIG. 8, the tennis training apparatus according to embodiment 1 includes: support frame assembly 10, ball collecting assembly 20, ball transmission assembly 30 and elastic ball feeding assembly 40. The ball collecting assembly 20 is adjacent to a side of the support frame assembly 10 close to a ball serving side. A ball inlet of the ball transmission assembly 30 is connected with the ball collecting assembly 20. The elastic ball feeding assembly 40 is connected with a ball outlet of the ball transmission assembly 30, and the elastic ball feeding assembly 40 is capable of ejecting a tennis ball to a side away from the support frame assembly 10.

According to the technical solution of this embodiment, the support frame assembly 10 achieves an effect of supporting the ball collecting assembly 20. After a practicer hits a tennis ball 300 to the ball collecting assembly 20, the ball collecting assembly 20 collects the ball and enters the ball transmission assembly 30, and the ball transmission assembly 30 transmits the tennis ball 300 to the elastic ball feeding assembly 40 to feed the ball. In this way, the number of times the staff picks up and throws the ball can be reduced, which greatly reduces the workload of the staff in picking up and throwing the ball, thereby improving the experience of the practicers. The technical solution of this embodiment effectively solves the problem in the related art that during tennis training, not only manpower is wasted, but the experience of practicers is also affected.

It is to be noted that the ball collecting assembly 20 includes a ball blocking curtain, ball blocking nets on both sides, and a folding ball collecting slot at a lower portion. A practicer hits the tennis ball 300 onto the ball blocking curtain, the ball blocking nets on both sides can prevent the tennis ball 300 from popping up, and the tennis ball 300 falls into the folding ball collecting slot which is arranged obliquely, and rolls into the ball transmission assembly 30 under the action of gravity. The folding ball collecting slot includes a plurality of inclined plates, and the plurality of inclined plates can be folded or unfolded.

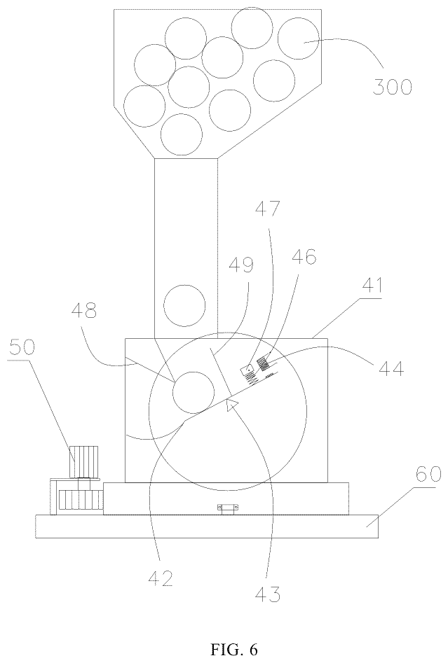

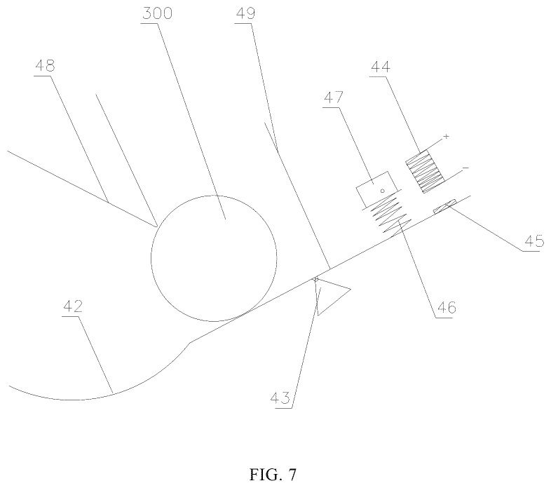

As shown in FIG. 6 and FIG. 7, in the technical solution of this embodiment, the elastic ball feeding assembly 40 includes a ball feeding shell 41, a rotating ball throwing arm 42, a rotating frame 43 and a first driving part, where the rotating frame 43 is mounted in the ball feeding shell 41, a middle portion of the rotating ball throwing arm 42 is rotatably connected with the rotating frame 43, a ball throwing end of the rotating ball throwing arm 42 is located on a side of the rotating frame 43 facing away from the support frame assembly 10, the first driving part is fitted with a force application end of the rotating ball throwing arm 42, and the force application end is located on a side of the rotating frame 43 away from the ball throwing end. The arrangement of the elastic ball feeding assembly 40 can save the trouble of manual ball throwing, the ball feeding shell 41 can protect internal components, and the arrangement of the rotating ball throwing arm 42, the rotating frame 43 and the first driving part can make the ball throwing effect better and the simulation more realistic. The position described above refers to a fitting part of the rotating frame 43 and the rotating ball throwing arm 42. The rotating frame 43 may be a support or a rotating shaft.

As shown in FIG. 6 and FIG. 7, in the technical solution of this embodiment, the first driving part includes an electromagnetic coil 44, a ferromagnetic body 45 and an elastic member 46, where the ferromagnetic body 45 is fixed on the force application end, the electromagnetic coil 44 is fixed on the ball feeding shell 41, a first end of the elastic member 46 is connected to the force application end between the ferromagnetic body 45 and the rotating frame 43, and a second end of the elastic member 46 is connected with the ball feeding shell 41. When the electromagnetic coil 44 is energized, the electromagnetic coil 44 attracts the ferromagnetic body 45. When the electromagnetic coil 44 is deenergized, there is no mutual attraction force between the electromagnetic coil 44 and the ferromagnetic body 45, at this time, the elastic member 46 applies elastic force to the rotating ball throwing arm 42, and the tennis ball 300 at the ball throwing end is suddenly thrown out, so that the practicer can hit the tennis ball 300 for training. It is to be noted that the elastic member 46 is a spring, and the spring is in a compressed state. The second end of the elastic member 46 may be connected with the ball feeding shell 41 either directly or indirectly. In this embodiment, the elastic ball feeding assembly 40 is located in the middle portion of the support frame assembly 10 in the left-right direction, and the ball blocking curtain is provided with a ball throwing hole. As another implementable embodiment, the elastic ball feeding assembly 40 may be disposed on a side of the ball collecting assembly 20 close to the practicer 100, and the practicer 100 holds the tennis racket 200 to hit the tennis ball 300, thereby saving the trouble of forming any ball throwing hole on the ball blocking curtain.

As shown in FIG. 6 and FIG. 7, in the technical solution of this embodiment, the first driving part further includes an elasticity adjuster 47, where the elasticity adjuster 47 includes an adjuster shell, a rotating shaft and an abutting block, the adjuster shell is connected with the ball feeding shell 41, the abutting block is fixedly connected with the rotating shaft, the rotating shaft is rotatably fixed on the adjuster shell, the abutting block abuts against the second end of the elastic member 46, and a distance from a circumferential outer wall of the abutting block to the rotating shaft varies. The arrange of the elasticity adjuster 47 can effectively change the ball throwing speed, ball throwing height and ball throwing force. It is to be noted that, the circumferential outer wall of the abutting block refers to a wall surface that abuts against the elastic member 46. Along with rotation of the rotating shaft, the fitting position of the abutting block and the elastic member 46 changes.

As shown in FIG. 6 and FIG. 7, in the technical solution of this embodiment, the ball polishing end is provided with a groove. The tennis ball 300 can automatically slide into the groove, and the arrangement of the groove makes it easy to position the tennis ball 300.

As shown in FIG. 6 and FIG. 7, in the technical solution of this embodiment, the elastic ball feeding assembly 40 further includes a ball storage box and a ball drop tube, where an upper end of the ball drop tube is communicated with the ball storage box, and a lower end of the ball drop tube is communicated with the ball feeding shell 41. The ball storage box can accommodate a plurality of tennis balls 300 at the same time, and the ball drop tube allows the tennis balls 300 to slide from the ball storage box into the ball feeding shell 41.

As shown in FIG. 6, in the technical solution of this embodiment, an inner diameter of the ball drop tube is greater than an outer diameter of a tennis ball and less than twice the outer diameter of the tennis ball. In this way, only one tennis ball 300 slides down at a time.

As shown in FIG. 6, in the technical solution of this embodiment, the elastic ball feeding assembly 40 further includes a first limiting part 48 fixed on an inner wall of the ball feeding shell 41, the rotating ball throwing arm 42 has a ball throwing state and a to-throw-ball state, in a case that the rotating ball throwing arm 42 is in the ball throwing state, a distance between a lower end of the first limiting part 48 and the rotating ball throwing arm 42 is less than the outer diameter of the tennis ball, and in a case that the rotating ball throwing arm 42 is in the to-throw-ball state, the distance between the lower end of the first limiting part 48 and the rotating ball throwing arm 42 is greater than the outer diameter of the tennis ball. The arrangement of the first limiting part 48 ensures that there is only one tennis ball 300 present in the groove. According to the fitting relationship between the first limiting part 48 and the rotating ball throwing arm 42, another tennis ball 300 can slide into the groove only after one tennis ball 300 is thrown out.

As shown in FIG. 6, in the technical solution of this embodiment, the rotating ball throwing arm 42 is provided with a ball drop point located between the ball throwing end and a rotary shaft of the rotating ball throwing arm 42, and the lower end of the first limiting part 48 is located between the ball drop point and the ball throwing end. The above ingenious structural arrangement greatly achieves the effect of outputting the tennis balls 300 into the groove one by one.

As shown in FIG. 6, in the technical solution of this embodiment, the elastic ball feeding assembly 40 further includes a second limiting part 49 located on the rotating ball throwing arm 42, in a case that the rotating ball throwing arm 42 is in the ball throwing state, the second limiting part 49 is at an avoidance position avoiding the lower end of the ball drop tube, and in a case that the rotating ball throwing arm 42 is in the to-throw-ball state, the second limiting part 49 is at a limiting position of the lower end of the ball drop tube. The second limiting part 49 is provided so that the tennis balls 300 can slide one by one into the ball feeding shell 41 from the ball drop tube, which avoids the phenomenon that the tennis balls 300 get stuck with each other.

As shown in FIG. 6, in the technical solution of this embodiment, the second limiting part 49 is a limiting arm having a first end connected with the rotating ball throwing arm 42, and a second extending away from the lower end of the ball drop tube. The limiting arm is simple in structure, low in processing cost and convenient to use.

As shown in FIG. 6 and FIG. 7, in the technical solution of this embodiment, the elastic ball feeding assembly 40 further includes a second driving part 50 and a mounting base 60, the second driving part is 50 fixed on the mounting base, the ball feeding shell 41 is rotatably mounted on the mounting base 60, and the second driving part 50 is capable of driving the mounting base 60 to rotate. The above structure expands the ball throwing range, that is, the elastic ball feeding assembly 40 not only throws the tennis ball 300 right forward, but also throws the tennis ball obliquely forward. In this way, the versatility of the tennis training apparatus is improved.

As shown in FIG. 6 and FIG. 7, in the technical solution of this embodiment, the second driving part 50 includes a rotating motor and a first gear, the elastic ball feeding assembly 40 further includes a second gear rotatably mounted on the mounting base 60, the ball feeding shell 41 is fixed on the second gear, an output end of the rotating motor is connected with the first gear, and the first gear is meshed with the second gear. The above structure is compact and high in transmission accuracy.

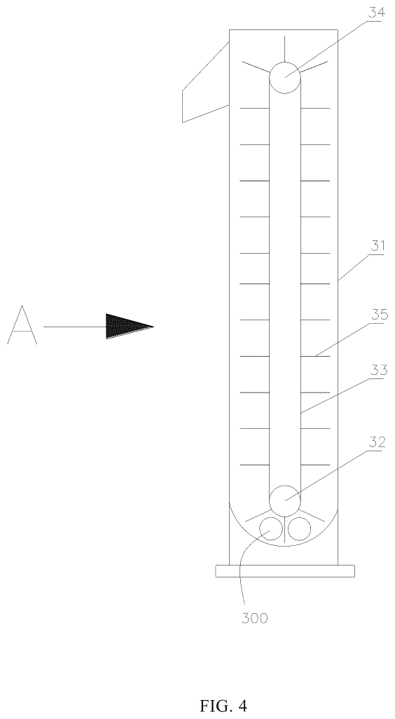

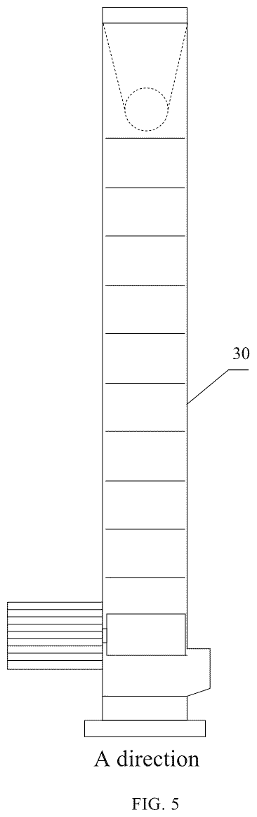

As shown in FIG. 4 and FIG. 5, in the technical solution of this embodiment, the ball transmission assembly 30 includes a transmission shell 31 and a driving wheel 32, an endless conveyor belt 33, a driven wheel 34 and a plurality of ball blocking plates 35 located in the transmission shell 31, the driving wheel 32 and the driven wheel 34 are located at two ends of the endless conveyor belt 33 respectively, the plurality of ball blocking plates 35 are disposed on an outer wall of the endless conveyor belt 33 at intervals, a bottom portion of the transmission shell 31 is provided with the ball inlet, a top portion of the transmission shell 31 is provided with the ball outlet, the ball inlet of the transmission shell 31 is connected with the ball collecting assembly 20, and the ball outlet of the transmission shell 31 is connected with the elastic ball feeding assembly 40. The arrangement of the ball transmission assembly 30 achieves the function of automatically transmitting tennis balls 300, thereby improving the degree of automation of the tennis training apparatus. Through the arrangement of the transmission shell 31, the driving wheel 32, the endless conveyor belt 33, the driven wheel 34 and the plurality of ball blocking plates 35, the tennis balls 300 can be transmitted continuously, which ensures the continuous transmission of tennis balls.

As shown in FIG. 4, in the technical solution of this embodiment, the quantity of the ball inlet is two, and the two ball inlets are located on wall surfaces of the transmission shell 31 on two sides of the endless conveyor belt 33 respectively, and are staggered. In this way, two tennis balls 300 can enter the transmission shell 31 at the same time. Through the above structure, the efficiency of transmitting the tennis balls 300 is improved.

As shown in FIG. 1, in the technical solution of this embodiment, the ball collecting assembly 20 is fixed on the support frame assembly 10. The above structure is stable, and achieves a great integration effect.

As shown in FIG. 1, in the technical solution of this embodiment, the tennis training apparatus further includes a control assembly 70 disposed on the support frame assembly 10. Through the arrangement of the control assembly 70, the degree of intelligence is further improved. The control assembly 70 may be a cloud server, a mobile phone, and/or a computer.

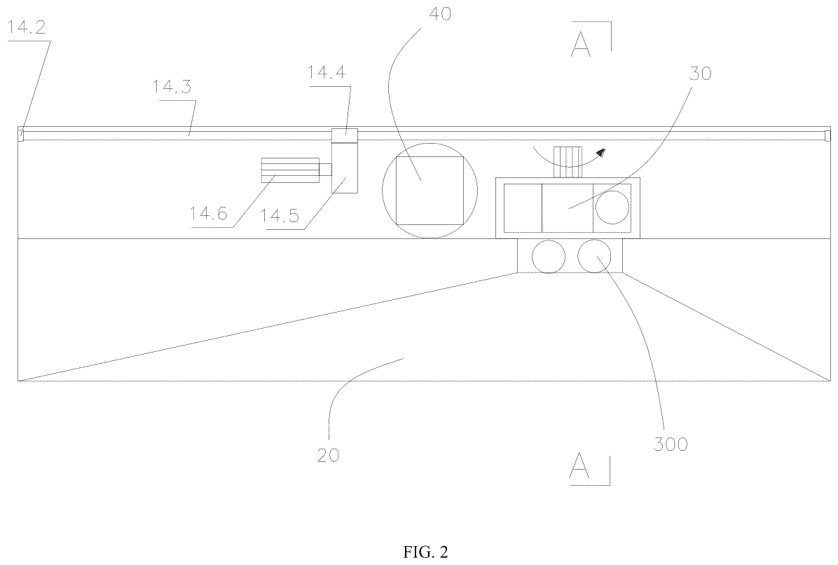

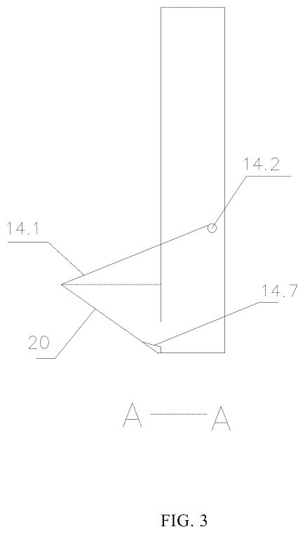

It is to be noted that, as shown in FIG. 2 and FIG. 3, the support frame assembly 10 further includes: 13. side net rotating shaft; 14. helical bevel gear A; 15. helical bevel gear B; 16. top net rotating shaft; 17. tubular motor; 18. external power line; 19. motor shaft and shaft sleeve; 14.1. drawing wire; 14.2. wire coiling wheel; 14.3. long shaft; 14.4. driven gear; 14.5. driving gear; 14.6. ball collecting slot folding motor; and 14.7. ball inlet hard plate.

It can be known from the above description that: The intelligent basic tennis training apparatus includes a main frame body, a ball hitting curtain, a folding ball collecting slot, a ball lifting system, a ball throwing system (elastic ball feeding assembly 40), a special tennis racket with a sensor, a retractable blocking net (cloth), a high-speed camera, a projector, an electrical control box, an operating button box, a cloud server, etc.

The main frame body (support frame assembly 10) includes an aluminum alloy profile frame and a closing plate. The dimension (width*height*thickness) of the main frame body is 3000*3000*300 mm. The ball hitting curtain, the folding ball collecting slot and the retractable blocking net (cloth) are mounted in the front of the main frame body; and the ball lifting system and the ball throwing system are mounted in the lower middle portion of the frame body; the high-speed camera and the projector are mounted on a front rod of the top retractable blocking net, and the electrical control and the operating system are mounted on the inner side of the main frame body. The tennis training apparatus can be mounted on the floors of various outdoor or indoor places with hard floors, making it suitable for tennis practicers at all stages, from beginning to advanced levels.

The tennis training apparatus is out of the factory in whole set, is mounted on the ground or hung on site, and can be put into use after being powered on. During training, first a power switch is enabled, then the code is scanned using a mobile phone to log in, the tennis training apparatus is started with one click, the front retractable blocking net (ball blocking net on two sides of the ball collecting assembly) automatically stretches out, and the ball lifting system, the ball throwing system, the high-speed camera 21 and the projector 22 automatically run. A racket and a certain quantity of tennis balls (e.g., 20 balls, if the practice is not the first time, there is no need to collect the ball, and the ball is pre-stored in the training apparatus) at the separate ball (tennis ball 300) and racket (tennis racket 200) collection box, and then ball serving exercising can be conducted. During ball serving practicing, the ball lifting system and the ball throwing system can be first turned off. The served ball is hit on the ball hitting curtain and drops into the folding ball collecting slot below, and is stored in the front of a ball inlet of the ball lifting system. After a basket of balls is all served, the tennis balls in the ball collecting slot can be picked up and put into the tennis basket, and after returning to position, ball serving practicing can be continued.

During ball hitting practicing, the ball lifting system and the ball throwing system are turned on in turn, and the ball throwing force and angle (or leftward ball hitting or rightward ball hitting is selected). The tennis ball in the ball collecting slot then can enter the ball throwing system through the ball lifting system and is thrown to a designated position according to a set direction and force for the practicer to practice ball hitting. The tennis ball hit is stroke on the ball hitting curtain and then drops into the ball collecting slot. In this way, ball hitting practicing is repeated.

During ball serving and ball hitting practicing, the high-speed camera of the apparatus records the body motions, ball hitting moments, and the initial flying trajectory of the ball during each ball serving/ball hitting and identifies them through a built-in specific algorithm, so that the flying trajectory and the drop point of the hit tennis ball in a standard tennis court are simulated and automatically compared with an evaluation standard of the apparatus, thereby giving the practicer a clear score. Then the evaluation result is projected on the ball hitting curtain.

When practice is stopped, first the ball throwing system is turned off while the ball lifting system is kept running for a certain period of time. After all the tennis balls in the ball collecting slot enter the ball storage box of the ball throwing system through the ball lifting system, the ball lifting system is then turned off, the retractable blocking net is reset, and the entire power supply is turned off. The practicer can settle the charge and view the statistical results of this training on the mobile phone.

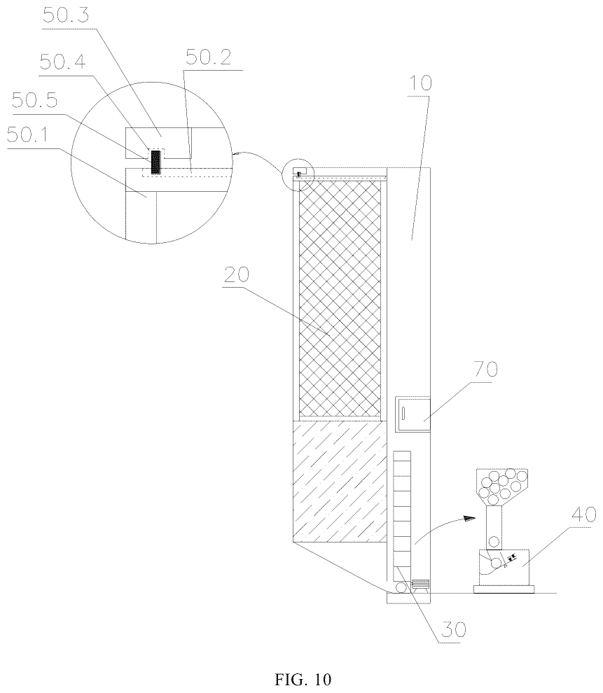

As shown in FIG. 10, the difference between the technical solution of Embodiment 2 and that of Embodiment 1 lies in that the tennis training apparatus is not provided with a control assembly 70. In this way, different tennis training apparatuses can be selected according to personal details.

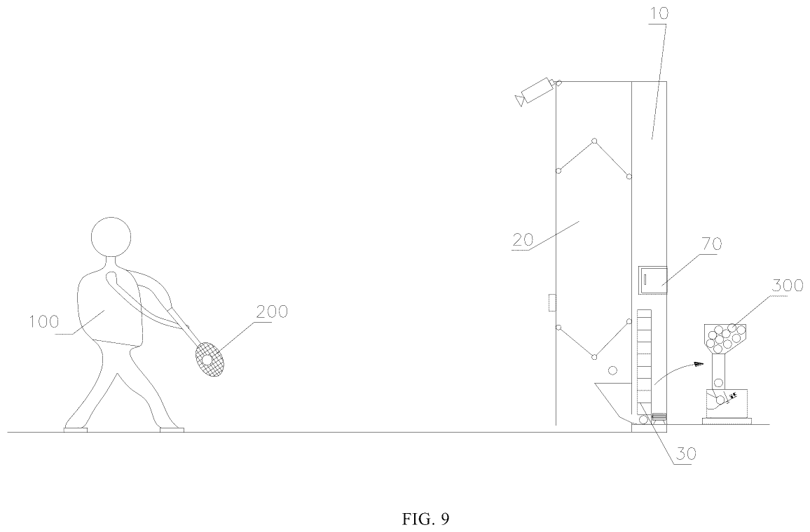

As shown in FIG. 9, the detailed structures of the ball collecting assembly 20 include: a side net frame 50.1, a side net frame elongated slot 50.2, a top net front beam 50.3, a top net front beam elongated slot 50.4 and a sliding pin 50.5. The side net frame 50.1 is retracted or unfolded through sliding of the sliding pin 50.5.

The tennis training apparatus is provided with retractable blocking nets (cloth) on the top and two sides of the main frame body. The high-speed camera is mounted on a cross rod of the upper edge of the main frame body. Instead of a projector, an LED electronic display is arranged on the upper portion of the ball hitting curtain and is configured to display the evaluation results of each ball hitting in real time. Light tubes or light strips are also mounted in the main frame body, and form a light box that can clearly display together with the ball hitting curtain, which makes it convenient for the practicer to clearly see the drop point of the tennis ball on the ball hitting curtain during practice at night. This embodiment is suitable for side nets and end nets mounted in an existing standard tennis court, and hanging is achieved by using special hanging brackets. When practicing is not needed, the field occupied is very small, so that the competition and training in the court are not affected.

The use method and training process are also the same as those in Embodiment 1, except that the simulation and evaluation results are not projected and displayed on the ball hitting curtain during practice, but are displayed on the LED display screen.

The difference between the technical solution of Embodiment 3 and Embodiment 1 lies in that, on the basis of Embodiment 1, there is no need to mount the high-speed camera, the projector, and the LED display screen, and no evaluation and simulation software is configured. Instead, the ball hitting curtain is divided into different scoring areas through lineation and color differentiation. If a tennis ball is hit in a certain ball drop area, it means that the tennis ball drops into a corresponding scoring area in a standard tennis court. The strengths and weakness of each ball hitting are roughly observed and judged by human eyes. Light tubes or light strips are also mounted in the main frame body, and form a light box that can clearly display together with the ball hitting curtain, which makes it convenient for the practicer to clearly see the drop point of the tennis ball on the ball hitting curtain during practice in poor lighting. This embodiment is suitable for use in schools of relatively backward places (such as remote mountainous areas) as well as other places, has low cost, needs little maintenance and is simple in operation. In order to prevent the tennis ball from flying out and being difficult to pick up in case of mounting outdoors, the retractable net (cloth) on the top surface and two sides of the main frame body is retained. The main frame body is mounted on the ground. Four ground feet are fixed on foundation embedded iron by bolts, or fixed on a leveled hardened ground by expansion bolts.

The use method and training process are also basically the same as those in Embodiment 1, except that each ball serving or ball hitting is not recognized and simulated, and computer software evaluation is not carried out. A simple determination is made simply by observing the ball landing position on the ball hitting curtain with the human eyes.

The method according to an embodiment of the present disclosure can be performed in a mobile phone, a controller, a server, a computer or a similar operation scheduling device.

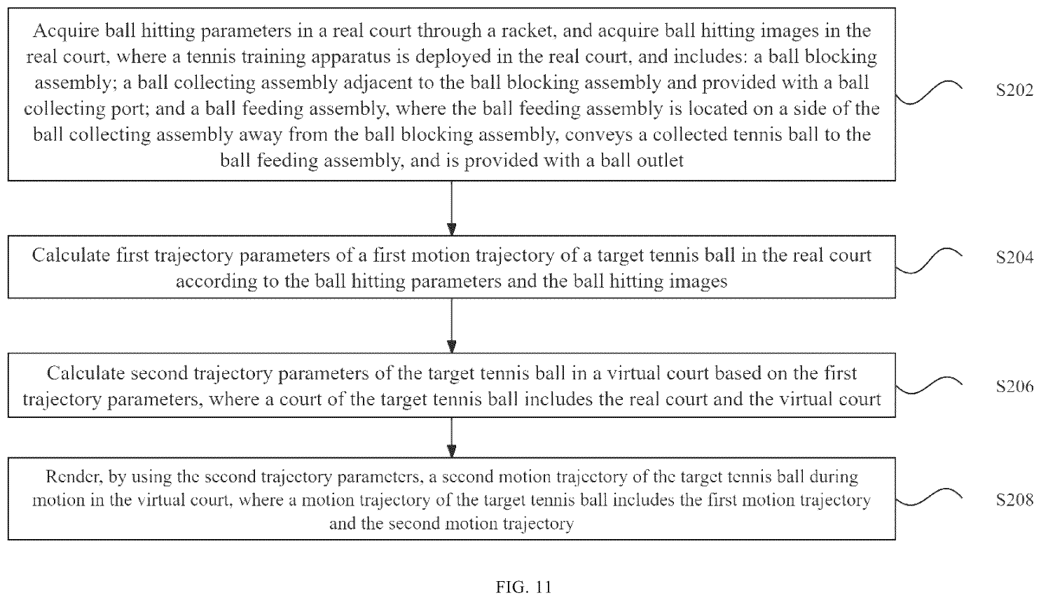

In this embodiment, a tennis training simulation method is provided. FIG. 11 is a flowchart of a tennis training simulation method according to an embodiment of the present disclosure. As shown in FIG. 11, the process includes the following steps:

Step S202: Acquire ball hitting parameters in a real court through a racket, and acquire ball hitting images in the real court, where a tennis training apparatus is deployed in the real court, and includes: a ball blocking assembly; a ball collecting assembly adjacent to the ball blocking assembly and provided with a ball collecting port; and a ball feeding assembly, where the ball feeding assembly is located on a side of the ball collecting assembly away from the ball blocking assembly, conveys a collected tennis ball to the ball feeding assembly, and is provided with a ball outlet. The solution of this embodiment can be applied to the training of ball hitting sports such as tennis, so that a real training effect can be simulated by using a small venue.

Step S204: Calculate first trajectory parameters of a first motion trajectory of a target tennis ball in the real court according to the ball hitting parameters and the ball hitting images. In an example, the first trajectory parameters include trajectory end point parameters of the first motion trajectory.

Step S206: Calculate second trajectory parameters of the target tennis ball in a virtual court based on the first trajectory parameters, where a court of the target tennis ball includes the real court and the virtual court. The virtual court in this embodiment is a three-dimensional virtual court, which is displayed on the boundary of the real court through a curtain, a display screen, etc. Thereby, the virtual court is combined with the real court to become a complete court.

Step S208: Render, by using the second trajectory parameters, a second motion trajectory of the target tennis ball during motion in the virtual court, where a motion trajectory of the target tennis ball includes the first motion trajectory and the second motion trajectory.

The first motion trajectory and the second motion trajectory form a complete motion trajectory of the target tennis ball. A user views the first motion trajectory along which the tennis ball flies in the real court with the naked eye, and views the second motion trajectory along which the tennis ball flies in the virtual court in real time on the display end, thereby enjoying the complete ball hitting process and experience.

According to the foregoing steps, ball hitting parameters in a real court are acquired through a racket, and ball hitting images in the real court are acquired; first trajectory parameters of a first motion trajectory of a target tennis ball in the real court are calculated according to the ball hitting parameters and the ball hitting images, and second trajectory parameters of the target tennis ball in a virtual court are calculated based on the first trajectory parameters, where a court of the target tennis ball includes the real court and the virtual court; a second motion trajectory of the target tennis ball during motion in the virtual court is rendered by using the second trajectory parameters, where a motion trajectory of the target tennis ball includes the first motion trajectory and the second motion trajectory. The first trajectory parameters of the target tennis ball during motion in the real court and the second trajectory parameters during motion in the virtual court are calculated, and the motion trajectory of the target tennis ball in the virtual court is rendered. The combination of the real court and the virtual court solves the venue limitations and addresses the technical problem that the sports venue cannot be expanded through the virtual court.

In an implementation of this embodiment, the acquire ball hitting parameters in a real court through a racket includes: acquiring a ball hitting speed in the real court through a speed sensor on the racket; acquiring a ball hitting angle in the real court through a direction sensor on the racket; acquiring a ball hitting height in the real court through a height sensor on the racket; where the ball hitting parameters include: the ball hitting speed, the ball hitting angle and the ball hitting height. The maximum values acquired by the speed sensor, the direction sensor, and the height sensor during a ball hitting process (contact between the ball and the racket face) are taken as the output ball hitting speed, ball hitting angle, and ball hitting height, respectively.

The ball hitting height in this embodiment may be the height of a center of the racket face. In some embodiments, the ball hitting position on the racket in the real court may also be acquired through a position sensor on the racket. In addition to acquisition by sensors, the acquisition can also be achieved by the following method: acquire image frames by an image sensor, locate the target tennis ball in the image frames through a target detection algorithm, and calculate the position change of the target tennis ball during the ball hitting process through image frames acquired for a continuous time, and then calculate the ball hitting parameters including the ball hitting speed, ball hitting angle and ball hitting height in combination with reference objects in the real court.

In this embodiment, the acquire ball hitting images in a real court includes: acquire, by a camera shooting unit, body action images and ball motion images during the ball hitting process, where a plurality of camera shooting units deployed at different positions of the real court, thereby achieving 360-degree panoramic image acquisition.

In an implementation of this embodiment, the calculate first trajectory parameters of a first motion trajectory of a target tennis ball in the real court according to the ball hitting parameters and the ball hitting images includes:

S11: Calculate first initial motion parameters of the target tennis ball by using the ball hitting parameters, where the first initial motion parameters include: a start point motion speed, a start point motion direction, and a start point height;

S12: Obtain an environmental resistance coefficient in a real court, where the environmental resistance coefficient may be an empirical value pre-configured in a control apparatus;

S13: Calculate trajectory end point parameters of the first motion trajectory of the target tennis ball in the real court by using the first initial motion parameters and the environmental resistance coefficient, where the trajectory end point parameters include: an end point motion speed, an end point motion direction, and an end point height.

S14: Modify the trajectory end point parameters of the first motion trajectory by using the ball hitting images.

The ball hitting images in this embodiment are used for the correction and selection of the ball hitting parameters. For example, through the ball hitting images, sensing data generated when the ball finally leaves the racket is selected as the first initial motion parameters; the motion speed, motion direction, and motion height of the ball are calculated by using body action images and ball motion images based on an image vision algorithm, and then subject to weighted summation with the ball hitting parameters acquired by the racket, or the maximum value is selected as the first initial motion parameter to be finally output.

By acquiring multiple frames of ball hitting images, such as key images of a tennis ball during the flying and at the end of the flying, and conducting sampling and calculating based on vision algorithms, the trajectory end point parameters of the dynamic trajectory (the first motion trajectory) can be obtained.

In an example, the calculation of trajectory end point parameters of the first motion trajectory of the target tennis ball in the real court by using the first initial motion parameters and the environmental resistance coefficient includes: obtain a first court length of the real court and obtain a ball weight of the target tennis ball; and set the first court length as a maximum horizontal length of the first motion trajectory of the target tennis ball in the real court, and calculate the trajectory end point parameters of the target tennis ball after the target tennis ball runs by the first court length by using the first initial motion parameters, the ball weight, and the environmental resistance coefficient.

Since the target tennis ball performs a parabolic falling motion horizontally or obliquely upwards after leaving the racket, a motion distance of the target tennis ball in the horizontal direction can be calculated if parameters such as the weight of the ball, environmental resistance coefficient, initial speed (velocity and direction), and a start point height are known. If a maximum horizontal length of horizontal motion is limited, the height, end point motion speed and end point motion direction of the ball when it reaches the longest horizontal length can be calculated reversely.

In another example of this embodiment, a sensor can also be provided on a display side (such as a projector curtain and a display screen) arranged at the boundary of the real court. The boundary is between the real court and the virtual court. The ball enters the virtual court through the boundary (visually). The sensor can sense drop point motion parameters of the target tennis ball when it reaches the boundary, and the drop point motion parameters are taken as the trajectory end point parameters including: an end point motion speed, an end point motion direction, and an end point height.

In an implementation of this embodiment, the calculate second trajectory parameters of the target tennis ball in a virtual court based on the first trajectory parameters includes: determine trajectory end point parameters of the first motion trajectory of the target tennis ball in the real court in the first trajectory parameters, where the trajectory end point parameters include: an end point motion speed, an end point motion direction, and an end point height; configure the trajectory end point parameters as second initial motion parameters of the target tennis ball in the virtual court; and calculate intermediate motion parameters and termination motion parameters of a simulated motion of the target tennis ball in a real scene by using the second initial motion parameters, and determine the intermediate motion parameters and the termination motion parameters as second trajectory parameters of the target tennis ball in the virtual court.

Since the real court and the virtual court in this embodiment are adjacent and seamlessly connected, and the boundary is a display side such as a curtain that displays the virtual court, the motion parameters of the ball at the end point of the real court (trajectory end point parameters) are the initial motion parameters of the virtual court. Based on the trajectory end point parameters, the ball continues to fly in the virtual court until it reaches the end point and stops. In this embodiment, firstly, the motion of a ball in a real scene is simulated by using the second initial motion parameters, and the motion parameters during the motion process and at the end of the motion are taken as the second trajectory parameters of the virtual court.

In an example, the render, by using the second trajectory parameters, a second motion trajectory of the target tennis ball during motion in the virtual court includes: fit a third motion trajectory of the target tennis ball on a world coordinate system by using the second trajectory parameters; obtain a thumbnail coordinate system of the virtual court, and convert the third motion trajectory from the world coordinate system to the thumbnail coordinate system to obtain the second motion trajectory; and dynamically display the second motion trajectory on a virtual screen of the virtual court.

The second trajectory parameters in this embodiment include the motion speed, direction, vertical height (relative to the ground reference), and horizontal height at multiple time points. Through fitting, a motion trajectory can be generated. Since the virtual court is scaled down in proportion to the real court, it is necessary to perform conversion and mapping according to a thumbnail coordinate system of the virtual court to obtain a reduced second motion trajectory (the second motion trajectory and the third motion trajectory have the same trend, different coordinate values).

In some embodiments, after the render, by using the second trajectory parameters, a second motion trajectory of the target tennis ball during motion in the virtual court, the method further includes: calculate ball hitting action parameters of a ball hitting person according to the ball hitting parameters and the ball hitting images, where the ball hitting action parameters are configured to represent an action standard degree of the ball hitting person during ball hitting; and calculate motion quality parameters of the target tennis ball in the virtual court according to the ball hitting parameters and the ball hitting images, where the motion quality parameters are configured to represent a standard degree of a motion trajectory after the target tennis ball is hit by the ball hitting person.

The ball hitting action parameters and motion quality parameters of this embodiment can be presented to the user through evaluation scores or levels and displayed on the client. The tennis-playing posture is corrected as follows: restore full-body actions of a player through human posture recognition of tracking data for hands, elbows, shoulders and waists, footwork and other key points, and compare the full-body actions with standard actions to obtain evaluation scores. In this way, the player can understand the inaccuracy of the playing posture and pursue higher expectations that are more in line with the standard posture, thereby improving the ball hitting level.

In an example, the calculate ball hitting action parameters of a ball hitting person according to the ball hitting parameters and the ball hitting images includes:

S21: parse a plurality of motion limb joints from the ball hitting images;

S22: select several key limb joints from the plurality of motion limb joints, where the key limb joints are limb joints required to exert force during tennis training, and the key limb joints include: hands, elbows, shoulders, waists and feet;

S23: create a dynamic 3D human body model by using the plurality of key limb joints, and calculate the ball hitting action parameters of the ball hitting person according to motion amplitudes of the dynamic 3D human body model; and

S24: modify the ball hitting action parameters by using the ball hitting parameters.

In some embodiments, the calculate the ball hitting action parameters of the ball hitting person according to motion amplitudes of the dynamic 3D human body model includes: capture the dynamic 3D human body model with a starting racket wielding time, an intermediate racket wielding time, and an ending racket wielding time; add a coordinate position combination of the key limb joints in a preset coordinate system after the dynamic 3D human body model is captured, where the coordinate position combination includes coordinate positions of a corresponding key limb joint at the starting racket wielding time, the intermediate racket wielding time, and the ending racket wielding time; for each key limb joint, sequentially connect all coordinate positions in the coordinate position combination according to a capturing time to generate a limb motion trajectory; calculate an action matching degree between the limb motion trajectory and a preset standard action trajectory; and determine the action matching degree as the ball hitting action parameters of the ball hitting person.

In addition to image visual recognition, recognition can also be achieved through hardware: mount a tracker on a front end of the racket to provide trajectory data, restore the trajectory of the racket by using a computer, and compare the trajectory with a standard racket trajectory to obtain evaluation scores or levels.

In an example, the calculate motion quality parameters of the target tennis ball in the virtual court according to the ball hitting parameters and the ball hitting images includes: calculate the first trajectory parameters of the first motion trajectory of the target tennis ball in the real court according to the ball hitting parameters and the ball hitting images; calculate the second trajectory parameters of the target tennis ball in the virtual court based on the first trajectory parameters; fit, by using the second trajectory parameters, the second motion trajectory of the target tennis ball during motion in the virtual court; calculate a posture matching degree between the second motion trajectory and a preset standard motion trajectory, where motion postures of the preset standard motion trajectory include: a direction, a radian, a speed, a drop point, and a height; and determine the posture matching degree as the motion quality parameters of the target tennis ball in the virtual court.

The ball hitting person is given an intuitive evaluation score by calculating and identifying trajectory parameters such as the drop point, ball speed, rotation, and radian of the tennis ball, calculating and simulating whether the hit tennis ball crosses the net, the flying attitude in the court after crossing the net, and the drop point (areas are divided based on the quality of the drop point), and partitioning the evaluation scores corresponding to the landing areas according to the ball hitting force, landing difficulty, etc.

In an implementation of this embodiment, after the calculate ball hitting action parameters of a ball hitting person according to the ball hitting parameters and the ball hitting images, the method further includes: determine whether the ball hitting action parameters are lower than a first standard threshold; if the ball hitting action parameters are lower than the first standard threshold, select a first limb joint with the lowest action parameter from a plurality of parameter items of the ball hitting action parameters, where the ball hitting action parameters include a plurality of parameter items, and each parameter item corresponds to one action parameter; search a preset database for a first action correction resource related to the first limb joint; and push the first action correction resource to a user terminal.

In another implementation of this embodiment, after the calculate motion quality parameters of the target tennis ball in the virtual court according to the ball hitting parameters and the ball hitting images, the method further includes: determine whether the motion quality parameters are lower than a second standard threshold; if the motion quality parameters are lower than the second standard threshold, select a motion posture with the lowest quality parameter from a plurality of parameter items of the motion quality parameters, where the motion quality parameters include a plurality of parameter items, and each parameter item corresponds to one quality parameter, and the motion posture includes: a direction, a radian and a speed; search a preset mapping table for a second limb joint with the greatest correlation with the motion posture; search a preset database for a second action correction resource related to the second limb joint; and push the second action correction resource to a user terminal.

The action correction resource in this embodiment can be teaching videos, pictures, text descriptions of standard actions, or can be teaching courses, purchase links, etc.

In some examples, before the acquire ball hitting parameters in a real court through a racket, and acquire ball hitting images in the real court, the method further includes: input training parameter information in a human-machine interface, where the training parameter information includes: player levels, training courses, and training programs; generate a first standard threshold of the ball hitting action parameters and a second standard threshold of the motion quality parameters by using the training parameter information.

In this embodiment, by calculating the ball hitting action parameters and motion quality parameters, the practicer or others can judge, based on the parameters, whether the practicer's actions and path of the ball meet the standards during online training, and then carry out targeted correction and improvement. The ball hitting person is provided with a comprehensive parameter indicator, so that they can summarize each ball hitting, and can intuitively see the progress, which improves interest and confidence in ball playing, and improves the efficiency of human-machine interaction.

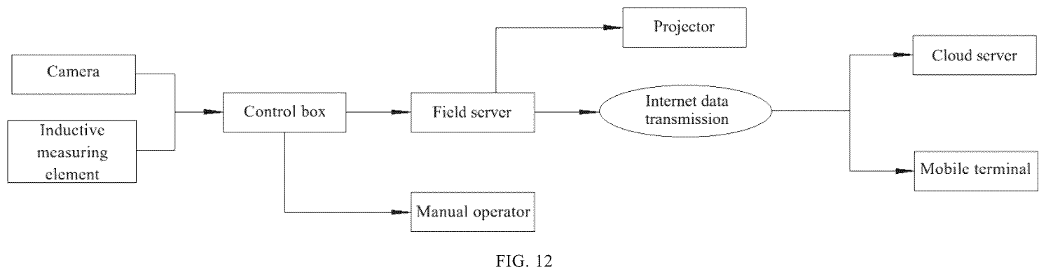

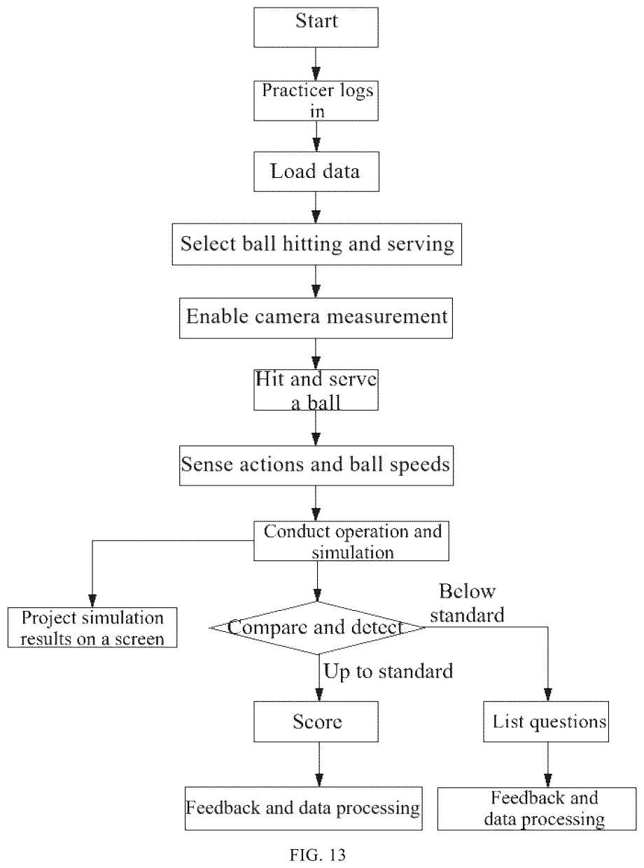

FIG. 12 is a structural diagram of a system according to an embodiment of the present disclosure, the system including: a camera, an inductive measuring element (speed sensor, etc.), a control box, a field server, a handheld box, a projector, a cloud server and a mobile terminal. FIG. 13 is an operation flowchart according to an embodiment of the present disclosure. Taking the target tennis ball as an example, the basic tennis simulation training method based on AI intelligent evaluation includes:
record, by a camera shooting unit, body actions and motion trajectories of a player at multiple points;
mount a sensing element on a special tennis racket to accurately capture a ball hitting force and angle of the racket;
simulate body joints of ball serving and forehand and backhand racket swinging actions of a player by using an artificial intelligence (AI) algorithm, and record action data for comparison to complete correction and modification of the player's actions;
record a flying trajectory of the tennis ball by using a tennis ball flying trajectory sensing unit, where the monitored data includes a ball speed, a position of a ball hitting point, a flying direction, etc.;
simulate the flying trajectory of the tennis ball by using a 3D algorithm, predict a height and a drop point of a hit tennis ball hit in the court, and judge the effectiveness of ball hitting; and realize playing scenes of virtual and real tennis courts by visualization functions to help the player judge the effectiveness of ball hitting.

The system of this embodiment functionally includes the following units:
a sensing unit including a data monitoring unit, configured to monitor and collect limb joints, tennis motion trajectory and other data of a player by using an infrared sensing unit, an RGB camera, etc;
a data transmission unit configured to convert the monitored and collected data into digital signals and transmit the same to a server;
a server central data control unit with powerful operational functions, configured to perform AI operations and 3D simulation on data, provide database parameter comparison, and give the player feedback on training results and action correction;
a server data storage and analysis unit, configured to accumulate, analyze and optimize the training effects of the player over a time period, and send a periodic analysis report;
a cloud platform management unit, configured to upload data of the player to a cloud platform through communication protocols such as the Internet and 5G for comprehensive backstage management;
an information sharing unit, configured to share information with the player by using a mobile APP, including account management, venue reservations, sports statistics, coach appointment and other functions; and
a natural human-machine interaction unit, configured to switch various functions and parameters of the system by using the human face, fingerprint or voice recognition functions, so as to improve the sports experience feeling of the player.

By monitoring the limb joint movement of the player and the tennis ball flying trajectory, including tennis ball serving and forehand and backhand racket swinging, beginners can quickly master and be proficient in the basic actions of tennis playing, adapt to tennis playing as soon as possible, and enjoy the joy of tennis.

The monitored data also includes limb joint data of the player, and key parameters such as hands, shoulders, waist, and footwork. The monitored data also includes the motion trajectory of the tennis racket, which is used to accurately simulate and evaluate the accuracy of body actions of the player. Multiple sets of tennis ball hitting simulation systems are arranged and can be connected to the server to store, analyze and share data. All terminal data can be connected to the Internet using 5G and other communication protocols to be synchronously shared on the cloud platform, so that interaction with users is conducted through a mobile APP. The tennis ball hitting simulation system also adopts the human face, fingerprint or voice recognition functions to facilitate the switching of various functions and parameters and improve the experience feeling of the player.

According to the solution of this embodiment, a simulation training method for basic tennis actions is recorded, the basic actions of tennis beginners such as the forehand and backhand ball hitting and ball serving are trained to quickly master basic tennis skills, so that the interest of tennis enthusiasts is improved, and the skills can be combined with actual tennis playing as soon as possible. A tennis beginner stands in a set position of a specific training area and swings the racket to hit the tennis ball that falls vertically from a fixed position above and rebounds from the ground, and hits the ball onto the curtain directly in front. The cameras and sensing devices disposed in this area can capture the body joint motions of the player's forehand and backhand racket swinging and ball serve through multiple sensing units, and transmit the data to the central computer processor. The ball hitting accuracy of the body motions is truly reflected by an advanced 3D algorithm system. By comparing the actions with the standard motions of players of different ages and genders in a database, corresponding AI evaluation scores are given, so as to help players correct actions, and offer data statistics and suggestions on players' action correction. At the same time, the sensing element in the training area can also capture the flying trajectory of the tennis ball, input the flying trajectory into a control center for analysis and calculation, calculate the flying speed, radian and direction of the tennis ball, and predict the specific drop point of the actual tennis court the tennis ball lands on after the tennis ball is hit, thereby helping the player judge the accuracy and effectiveness of ball hitting, and adjust the force, radian and direction of ball hitting in a timely manner. This basic tennis training simulation method based on AI intelligent evaluation can help tennis beginners quickly master the basic actions of tennis through repeated ball hitting training in situ, correct the bad habits of tennis beginners, and overcome the nervous mood of beginners, thereby achieving the purpose of a quick start of tennis sports. By properly using the training simulation method, tennis beginners can reach level 3.0-3.5 (in accordance with the United States Tennis Association's National Tennis Rating Program (NTRP) standards) in a short period of time, thereby quickly overcoming the obstacle period in the early stages of learning and enjoying the joy of tennis, which effectively drives the popularization and promotion of tennis to all the people.

By means of the above description of the examples, those skilled in the art can clearly understand that the above method in the examples may be implemented by means of software and a necessary general-purpose hardware platform. Certainly, the hardware may be used, but the former is a better implementation manner in many cases. Based on this understanding, the technical solution of the present disclosure essentially, or a part contributing to the prior art, may be embodied in a form of a software product. The computer software product is stored on a storage medium (such as a ROM/RAM, a magnetic disk, an optical disk), and includes several instructions to enable a terminal device (may be a mobile phone, a computer, a server, or a network device) to execute the method according to each example of the present disclosure.

This embodiment further provides a tennis training simulation apparatus for implementing the foregoing embodiments and implementations, which have been illustrated and are not described again. As used below, the term “module” may implement the combination of software and/or hardware having predetermined functions. Although the apparatus described in the following embodiments is preferably implemented by software, implementation by hardware or the combination of the software and the hardware is also possible and may be conceived.

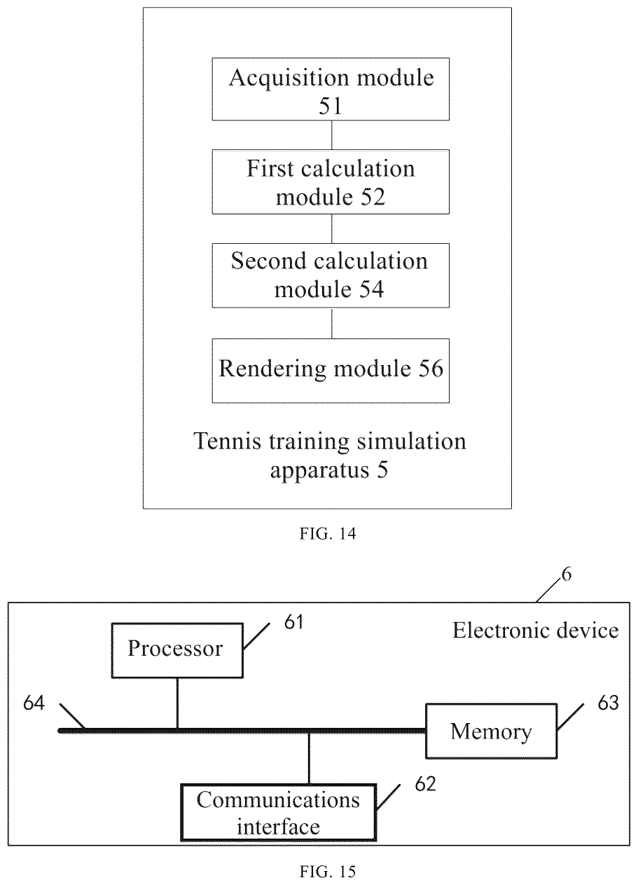

FIG. 14 is a structural block diagram of a tennis training simulation apparatus 5 according to an embodiment of the present disclosure. As shown in FIG. 14, the apparatus includes: an acquisition module 51, a first calculation module 52, a second calculation module 54, and a rendering module 56, where
the acquisition module 51 is configured to acquire ball hitting parameters in a real court through a racket, and acquire ball hitting images in the real court, where a tennis training apparatus is deployed in the real court, and includes: a ball blocking assembly; a ball collecting assembly adjacent to the ball blocking assembly and provided with a ball collecting port; and a ball feeding assembly, where the ball feeding assembly is located on a side of the ball collecting assembly away from the ball blocking assembly, conveys a collected tennis ball to the ball feeding assembly, and is provided with a ball outlet;
the first calculation module 52 is configured to calculate the first trajectory parameters of the first motion trajectory of the target tennis ball in the real court according to the ball hitting parameters and the ball hitting images;
the second calculation module 54 is configured to calculate second trajectory parameters of the target tennis ball in a virtual court based on the first trajectory parameters, where a court of the target tennis ball includes the real court and the virtual court; and
the rendering module 56 is configured to render, by using the second trajectory parameters, a second motion trajectory of the target tennis ball during motion in the virtual court, where a motion trajectory of the target tennis ball includes the first motion trajectory and the second motion trajectory.

In some embodiments, the acquisition module includes: a first acquisition unit, configured to acquire a ball hitting speed in the real court through a speed sensor on the racket; a second acquisition unit, configured to acquire a ball hitting angle in the real court through a direction sensor on the racket; a third acquisition unit, configured to acquire a ball hitting height in the real court through a height sensor on the racket; a fourth acquisition unit, configured to acquire a ball hitting force in the real court through a force sensor on the racket; and a fifth acquisition unit, configured to acquire a racket wielding trajectory in the real court through a tracker on the racket; where the ball hitting parameters include: the ball hitting speed, the ball hitting angle, the ball hitting height, the ball hitting force and the ball wielding trajectory.

In some embodiments, the first calculation module includes: a first calculation unit, configured to calculate first initial motion parameters of the target tennis ball by using the ball hitting parameters, where the first initial motion parameters include: a start point motion speed, a start point motion direction, and a start point height; an obtaining unit, configured to obtain an environmental resistance coefficient in the real court; a second calculation unit, configured to calculate trajectory end point parameters of the first motion trajectory of the target tennis ball in the real court by using the first initial motion parameters and the environmental resistance coefficient, where the trajectory end point parameters include: an end point motion speed, an end point motion direction, and an end point height; and a modification unit, configured to modify the trajectory end point parameters of the first motion trajectory by using the ball hitting images.

In some embodiments, the second calculation unit includes: an obtaining subunit, configured to obtain a first court length of the real court and obtain a ball weight of the target tennis ball; and a calculation subunit, configured to set the first court length as a maximum horizontal length of the first motion trajectory of the target tennis ball in the real court, and calculate the trajectory end point parameters of the target tennis ball after the target tennis ball runs by the first court length by using the first initial motion parameters, the ball weight, and the environmental resistance coefficient.

In some embodiments, the second calculation module includes: a determining unit, configured to determine trajectory end point parameters of the first motion trajectory of the target tennis ball in the real court in the first trajectory parameters, where the trajectory end point parameters include: an end point motion speed, an end point motion direction, and an end point height; a configuring unit, configured to configure the trajectory end point parameters as second initial motion parameters of the target tennis ball in the virtual court; and a calculation unit, configured to calculate intermediate motion parameters and termination motion parameters of a simulated motion of the target tennis ball in a real scene by using the second initial motion parameters, and determine the intermediate motion parameters and the termination motion parameters as second trajectory parameters of the target tennis ball in the virtual court.

In some embodiments, the rendering module includes: a fitting unit, configured to fit a third motion trajectory of the target tennis ball on a world coordinate system by using the second trajectory parameters; a conversion unit, configured to obtain a thumbnail coordinate system of the virtual court, and convert the third motion trajectory from the world coordinate system to the thumbnail coordinate system to obtain the second motion trajectory; and a display unit, configured to dynamically display the second motion trajectory on a virtual screen of the virtual court.

In some embodiments, the apparatus further includes: a third calculation module, configured to calculate ball hitting action parameters of a ball hitting person according to the ball hitting parameters and the ball hitting images after the rendering module renders, by using the second trajectory parameters, a second motion trajectory of the target tennis ball during motion in the virtual court, where the ball hitting action parameters are configured to represent an action standard degree of the ball hitting person during ball hitting; and a fourth calculation module, configured to calculate motion quality parameters of the target tennis ball in the virtual court according to the ball hitting parameters and the ball hitting images, where the motion quality parameters are configured to represent a standard degree of a motion trajectory after the target tennis ball is hit by the ball hitting person.

In some embodiments, the third calculation module includes: a parsing unit, configured to parse a plurality of motion limb joints from the ball hitting images; a selection unit, configured to select several key limb joints from the plurality of motion limb joints, where the key limb joints are limb joints required to exert force during tennis training, and the key limb joints include: hands, elbows, shoulders, waists and feet; a calculation unit, configured to create a dynamic 3D human body model by using the plurality of key limb joints, and calculate the ball hitting action parameters of the ball hitting person according to motion amplitudes of the dynamic 3D human body model; and a modification unit, configured to modify the ball hitting action parameters by using the ball hitting parameters.

In some embodiments, the calculation unit includes: a capturing subunit, configured to capture the dynamic 3D human body model with a starting racket wielding time, an intermediate racket wielding time, and an ending racket wielding time; an adding subunit, configured to add a coordinate position combination of the key limb joints in a preset coordinate system after the dynamic 3D human body model is captured, where the coordinate position combination includes coordinate positions of a corresponding key limb joint at the starting racket wielding time, the intermediate racket wielding time, and the ending racket wielding time; a connection subunit, configured to, for each key limb joint, sequentially connect all coordinate positions in the coordinate position combination according to a capturing time to generate a limb motion trajectory; a calculated subunit, configured to calculate an action matching degree between the limb motion trajectory and a preset standard action trajectory; and a determining subunit, configured to determine the action matching degree as the ball hitting action parameters of the ball hitting person.

In some embodiments, the fourth calculation module includes: a first calculation unit, configured to calculate the first trajectory parameters of the first motion trajectory of the target tennis ball in the real court according to the ball hitting parameters and the ball hitting images; a second calculation unit, configured to calculate the second trajectory parameters of the target tennis ball in the virtual court based on the first trajectory parameters; a fitting unit, configured to fit, by using the second trajectory parameters, the second motion trajectory of the target tennis ball during motion in the virtual court; a third calculation unit, configured calculate a posture matching degree between the second motion trajectory and a preset standard motion trajectory, where motion postures of the preset standard motion trajectory include: a direction, a radian, a speed, a drop point, and a height; and a determining unit, configured to determine the posture matching degree as the motion quality parameter of the target tennis ball in the virtual court.

It is to be noted that, each of the above modules may be implemented by software or hardware. The latter can be implemented through the following manner, which is not limited thereto: the above modules are all located in the same processor; or the above modules, in any combination, can be located in different processors.

The embodiment of the present disclosure also provides a storage medium storing a computer program, where the computer program, when executed, implements the steps of the method according to the present disclosure.

In some embodiments, the foregoing storage medium may be configured to store a computer program used for implementing the following steps:

S1: Acquire ball hitting parameters in a real court through a racket, and acquire ball hitting images in the real court, where a tennis training apparatus is deployed in the real court, and includes: a ball blocking assembly; a ball collecting assembly adjacent to the ball blocking assembly and provided with a ball collecting port; and a ball feeding assembly, where the ball feeding assembly is located on a side of the ball collecting assembly away from the ball blocking assembly, conveys a collected tennis ball to the ball feeding assembly, and is provided with a ball outlet;

S2: calculate the first trajectory parameters of the first motion trajectory of the target tennis ball in the real court according to the ball hitting parameters and the ball hitting images;

S3: Calculate second trajectory parameters of the target tennis ball in a virtual court based on the first trajectory parameters, where a court of the target tennis ball includes the real court and the virtual court; and

S4: Render, by using the second trajectory parameters, a second motion trajectory of the target tennis ball during motion in the virtual court, where a motion trajectory of the target tennis ball includes the first motion trajectory and the second motion trajectory.

In some embodiments, the foregoing storage medium may include, but is not limited to: a USB flash disk, a read-only memory (known as ROM), a random access memory (known as RAM), a mobile hard disk, a magnetic disk, an optical disk, or other media capable of storing a computer program.

As shown in FIG. 15, an embodiment of the present disclosure further provides an electronic device 6, the electronic device including a processor 61, a communications interface 62, a memory 63, and a communications bus 64. The processor 61, the communications interface 62, and the memory 63 communicate with each other through the communications bus 64. The memory 63 stores a computer program, and the processor 61 is configured to execute the computer program stored in the memory 63 to implement the steps of the method according to the present disclosure.

In some embodiments, the foregoing electronic device 6 may further include a transmission apparatus and an input/output apparatus (not shown in the figure), where the transmission apparatus is connected to the processor 61 described above, and the input/output apparatus is connected to the processor 61 described above.

The memory 63 may include a high-speed random memory, and may further include a non-volatile memory, for example, one or more magnetic storage apparatuses, a flash memory, or another nonvolatile solid-state memory. In some examples, the memory 63 may further include memories remotely disposed relative to the processor 61, and the remote memories may be connected to a server through a network. Examples of the network include, but are not limited to, the Internet, an intranet, a local area network, a mobile communication network, and a combination thereof.

In some embodiments, the foregoing processor 61 may be set to perform following steps by the computer program:

S1: Acquire ball hitting parameters in a real court through a racket, and acquire ball hitting images in the real court, where a tennis training apparatus is deployed in the real court, and includes: a ball blocking assembly; a ball collecting assembly adjacent to the ball blocking assembly and provided with a ball collecting port; and a ball feeding assembly, where the ball feeding assembly is located on a side of the ball collecting assembly away from the ball blocking assembly, conveys a collected tennis ball to the ball feeding assembly, and is provided with a ball outlet;

S2: calculate the first trajectory parameters of the first motion trajectory of the target tennis ball in the real court according to the ball hitting parameters and the ball hitting images;

S3: Calculate second trajectory parameters of the target tennis ball in a virtual court based on the first trajectory parameters, where a court of the target tennis ball includes the real court and the virtual court; and

S4: Render, by using the second trajectory parameters, a second motion trajectory of the target tennis ball during motion in the virtual court, where a motion trajectory of the target tennis ball includes the first motion trajectory and the second motion trajectory.

In some embodiments, for the specific example in this embodiment, reference may be made to the example described in the embodiments and optional implementations described above. Details are not described herein again.

In the foregoing embodiments of the present disclosure, the descriptions of the embodiments have different focuses. For a part that is not detailed in an embodiment, reference may be made to the relevant description of other embodiments.

In several embodiments provided in the present disclosure, it is to be understood that, the disclosed technical content may be implemented in another manner. The foregoing described apparatus embodiments are merely examples. For example, the unit division is merely logical function division and there may be other division methods in actual implementation. For example, multiple units or components may be combined or integrated into another system, or some features may be omitted or not performed. In addition, the coupling, or direct coupling, or communication connection between the displayed or discussed components may be the indirect coupling or communication connection by means of some interfaces, units, or modules, and may be electrical or of other forms.

The units described as separate parts may or may not be physically separate, and parts displayed as units may or may not be physical units, may be located in one location, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units may be integrated into one unit. The integrated unit may be implemented in the form of hardware, or may be implemented in a form of a software functional unit.

In a case that the integrated unit is implemented in a form of a software functional unit and sold or used as an independent product, the integrated unit may be stored in the computer-readable storage medium. Based on such an understanding, the technical solution of the present disclosure essentially, or the part contributing to the related art, or all or part of the technical solution may be presented in the form of a software product. The computer software product is stored in the storage medium, and includes several instructions for enabling a computer device (which may be a personal computer, a server, a network device, or the like) to perform all or some steps of the method according to each embodiment of the present disclosure. The foregoing storage medium includes: a USB flash disk, a read-only memory (ROM), a random access memory (RAM), a mobile hard disk, a magnetic disk, an optical disc, or other media capable of storing program code.

The above are merely specific implementations of the present disclosure, so as to enable those skilled in the art to understand or implement the present disclosure. Various modifications to these embodiments are readily apparent to those skilled in the art, and the general principles defined herein may be implemented in other embodiments without departing from the essence or scope of the present disclosure. Therefore, the present disclosure is not to be limited to these embodiments shown herein, but is to conform with the widest scope consistent with the principles and novel features disclosed herein.

What is claimed is:

1. A tennis training apparatus, comprising:
a support frame assembly;
a ball collecting assembly adjacent to a side of the support frame assembly adjacent to a ball serving side;
a ball transmission assembly, wherein a ball inlet of the ball transmission assembly is connected with the ball collecting assembly; and
an elastic ball feeding assembly, wherein the elastic ball feeding assembly is connected with a ball outlet of the ball transmission assembly and configured for ejecting a tennis ball to a side away from the support frame assembly;
wherein the elastic ball feeding assembly comprises a ball feeding shell, a rotating ball throwing arm, a rotating frame and a first driving part, wherein the rotating frame is mounted in the ball feeding shell, a middle portion of the rotating ball throwing arm is rotatably connected with the rotating frame, a ball throwing end of the rotating ball throwing arm is located on a first side of the rotating frame facing away from the support frame assembly, the first driving part is fitted with a force application end of the rotating ball throwing arm, and the force application end is located on a second side of the rotating frame away from the ball throwing end.

2. The tennis training apparatus according to claim 1, wherein the first driving part comprises an electromagnetic coil, a ferromagnetic body and an elastic member, wherein the ferromagnetic body is fixed on the force application end, the electromagnetic coil is fixed on the ball feeding shell, a first end of the elastic member is connected to the force application end between the ferromagnetic body and the rotating frame, and a second end of the elastic member is connected with the ball feeding shell.

3. The tennis training apparatus according to claim 2, wherein the first driving part further comprises an elasticity adjuster, wherein the elasticity adjuster comprises an adjuster shell, a rotating shaft and an abutting block, the adjuster shell is connected with the ball feeding shell, the abutting block is fixedly connected with the rotating shaft, the rotating shaft is rotatably fixed on the adjuster shell, the abutting block abuts against the second end of the elastic member, and a distance from a circumferential outer wall of the abutting block to the rotating shaft varies.

4. The tennis training apparatus according to claim 1, wherein the elastic ball feeding assembly further comprises a ball storage box and a ball drop tube, wherein an upper end of the ball drop tube is communicated with the ball storage box, and a lower end of the ball drop tube is communicated with the ball feeding shell;
the ball throwing end is provided with a groove; and
an inner diameter of the ball drop tube is greater than an outer diameter of the tennis ball and less than twice the outer diameter of the tennis ball.

5. The tennis training apparatus according to claim 4, wherein the elastic ball feeding assembly further comprises a first limiting part fixed on an inner wall of the ball feeding shell, and the rotating ball throwing arm has a ball throwing state and a to-throw-ball state, wherein when the rotating ball throwing arm is in the ball throwing state, a distance between a lower end of the first limiting part and the rotating ball throwing arm is less than the outer diameter of the tennis ball; and when the rotating ball throwing arm is in the to-throw-ball state, the distance between the lower end of the first limiting part and the rotating ball throwing arm is greater than the outer diameter of the tennis ball.

6. The tennis training apparatus according to claim 5, wherein the rotating ball throwing arm is provided with a ball drop point located between the ball throwing end and a rotary shaft of the rotating ball throwing arm, and the lower end of the first limiting part is located between the ball drop point and the ball throwing end.

7. The tennis training apparatus according to claim 5, wherein the elastic ball feeding assembly further comprises a second limiting part located on the rotating ball throwing arm, wherein when the rotating ball throwing arm is in the ball throwing state, the second limiting part is at an avoidance position avoiding the lower end of the ball drop tube; and when the rotating ball throwing arm is in the to-throw-ball state, the second limiting part is at a limiting position of the lower end of the ball drop tube.

8. The tennis training apparatus according to claim 7, wherein the second limiting part is a limiting arm, wherein a first end of the limiting arm is connected with the rotating ball throwing arm, and a second end of the limiting arm extends away from the lower end of the ball drop tube.

9. The tennis training apparatus according to claim 1, wherein the elastic ball feeding assembly further comprises a second driving part and a mounting base, wherein the second driving part is fixed on the mounting base, the ball feeding shell is rotatably mounted on the mounting base, and the second driving part is configured for driving the mounting base to rotate; and
the second driving part comprises a rotating motor and a first gear, and the elastic ball feeding assembly further comprises a second gear rotatably mounted on the mounting base, wherein the ball feeding shell is fixed on the second gear, an output end of the rotating motor is connected with the first gear, and the first gear is meshed with the second gear.

10. The tennis training apparatus according to claim 1, wherein the ball transmission assembly comprises a transmission shell, a driving wheel, an endless conveyor belt, a driven wheel and a plurality of ball blocking plates, wherein the driving wheel, the endless conveyor belt, the driven wheel and the plurality of ball blocking plates are located in the transmission shell, the driving wheel and the driven wheel are located at two ends of the endless conveyor belt respectively, the plurality of ball blocking plates are disposed on an outer wall of the endless conveyor belt at intervals, a bottom portion of the transmission shell is provided with the ball inlet, a top portion of the transmission shell is provided with the ball outlet, the ball inlet of the transmission shell is connected with the ball collecting assembly, and the ball outlet of the transmission shell is connected with the elastic ball feeding assembly; and
a quantity of the ball inlet is two, and the two ball inlets are located on wall surfaces of the transmission shell on two sides of the endless conveyor belt respectively, and are staggered.

11. The tennis training apparatus according to claim 1, wherein the ball collecting assembly is fixed on the support frame assembly; and
the tennis training apparatus further comprises a control assembly disposed on the support frame assembly.

12. A tennis training simulation method, comprising:
acquiring ball hitting parameters in a real court through a racket, and acquiring ball hitting images in the real court, wherein the tennis training apparatus according to claim 1 is deployed in the real court;
calculating first trajectory parameters of a first motion trajectory of a target tennis ball in the real court according to the ball hitting parameters and the ball hitting images;
calculating second trajectory parameters of the target tennis ball in a virtual court based on the first trajectory parameters, wherein a court of the target tennis ball comprises the real court and the virtual court; and
rendering, by using the second trajectory parameters, a second motion trajectory of the target tennis ball during a motion in the virtual court, wherein a motion trajectory of the target tennis ball comprises the first motion trajectory and the second motion trajectory.

13. The tennis training simulation method according to claim 12, wherein the step of acquiring the ball hitting parameters in the real court through the racket comprises:
acquiring a ball hitting speed in the real court through a speed sensor on the racket;
acquiring a ball hitting angle in the real court through a direction sensor on the racket;
acquiring a ball hitting height in the real court through a height sensor on the racket;
acquiring a ball hitting force in the real court through a force sensor on the racket; and
acquiring a racket wielding trajectory in the real court through a tracker on the racket;
wherein the ball hitting parameters comprise: the ball hitting speed, the ball hitting angle, the ball hitting height, the ball hitting force and the ball wielding trajectory;
wherein the step of calculating the first trajectory parameters of the first motion trajectory of the target tennis ball in the real court according to the ball hitting parameters and the ball hitting images comprises:
calculating first initial motion parameters of the target tennis ball by using the ball hitting parameters, wherein the first initial motion parameters comprise: a start point motion speed, a start point motion direction, and a start point height;
obtaining an environmental resistance coefficient in the real court;
calculating trajectory end point parameters of the first motion trajectory of the target tennis ball in the real court by using the first initial motion parameters and the environmental resistance coefficient, wherein the trajectory end point parameters comprise: an end point motion speed, an end point motion direction and an end point height; and
modifying the trajectory end point parameters of the first motion trajectory by using the ball hitting images;
wherein the step of calculating the second trajectory parameters of the target tennis ball in the virtual court based on the first trajectory parameters comprises:
determining the trajectory end point parameters of the first motion trajectory of the target tennis ball in the real court in the first trajectory parameters, wherein the trajectory end point parameters comprise: the end point motion speed, the end point motion direction and the end point height;
configuring the trajectory end point parameters as second initial motion parameters of the target tennis ball in the virtual court; and
calculating intermediate motion parameters and termination motion parameters of a simulated motion of the target tennis ball in a real scene by using the second initial motion parameters, and determining the intermediate motion parameters and the termination motion parameters as the second trajectory parameters of the target tennis ball in the virtual court;
wherein the step of rendering, by using the second trajectory parameters, the second motion trajectory of the target tennis ball during the motion in the virtual court comprises:
fitting a third motion trajectory of the target tennis ball on a world coordinate system by using the second trajectory parameters;
obtaining a thumbnail coordinate system of the virtual court, and converting the third motion trajectory from the world coordinate system to the thumbnail coordinate system to obtain the second motion trajectory; and
dynamically displaying the second motion trajectory on a virtual screen of the virtual court.

14. The tennis training simulation method according to claim 13, wherein the step of calculating the trajectory end point parameters of the first motion trajectory of the target tennis ball in the real court by using the first initial motion parameters and the environmental resistance coefficient comprises:
obtaining a first court length of the real court and obtaining a ball weight of the target tennis ball; and
setting the first court length as a maximum horizontal length of the first motion trajectory of the target tennis ball in the real court, and calculating the trajectory end point parameters of the target tennis ball after the target tennis ball runs by the first court length by using the first initial motion parameters, the ball weight, and the environmental resistance coefficient.

15. The tennis training simulation method according to claim 12, wherein after the step of rendering, by using the second trajectory parameters, the second motion trajectory of the target tennis ball during the motion in the virtual court, the tennis training simulation method further comprises:
calculating ball hitting action parameters of a ball hitting person according to the ball hitting parameters and the ball hitting images, wherein the ball hitting action parameters are configured to represent an action standard degree of the ball hitting person during ball hitting; and
calculating motion quality parameters of the target tennis ball in the virtual court according to the ball hitting parameters and the ball hitting images, wherein the motion quality parameters are configured to represent a standard degree of a motion trajectory after the target tennis ball is hit by the ball hitting person.

16. The tennis training simulation method according to claim 15, wherein the step of calculating the ball hitting action parameters of the ball hitting person according to the ball hitting parameters and the ball hitting images comprises:
parsing a plurality of motion limb joints from the ball hitting images;
selecting a plurality of key limb joints from the plurality of motion limb joints, wherein the plurality of key limb joints are required to exert force during tennis training, and the plurality of key limb joints comprise: hands, elbows, shoulders, waists and feet;
creating a dynamic 3D human body model by using the plurality of key limb joints, and calculating the ball hitting action parameters of the ball hitting person according to motion amplitudes of the dynamic 3D human body model; and
modifying the ball hitting action parameters by using the ball hitting parameters;
wherein the step of calculating the motion quality parameters of the target tennis ball in the virtual court according to the ball hitting parameters and the ball hitting images comprises:
calculating the first trajectory parameters of the first motion trajectory of the target tennis ball in the real court according to the ball hitting parameters and the ball hitting images;
calculating the second trajectory parameters of the target tennis ball in the virtual court based on the first trajectory parameters;
fitting, by using the second trajectory parameters, the second motion trajectory of the target tennis ball during the motion in the virtual court;
calculating a posture matching degree between the second motion trajectory and a preset standard motion trajectory, wherein motion postures of the preset standard motion trajectory comprise: a direction, a radian, a speed, a drop point and a height; and
determining the posture matching degree as the motion quality parameters of the target tennis ball in the virtual court.

17. The tennis training simulation method according to claim 16, wherein the step of calculating the ball hitting action parameters of the ball hitting person according to the motion amplitudes of the dynamic 3D human body model comprises:
capturing the dynamic 3D human body model with a starting racket wielding time, an intermediate racket wielding time and an ending racket wielding time;
adding a coordinate position combination of the plurality of key limb joints in a preset coordinate system after the dynamic 3D human body model is captured, wherein the coordinate position combination comprises coordinate positions of a corresponding key limb joint at the starting racket wielding time, the intermediate racket wielding time and the ending racket wielding time;
for each of the plurality of key limb joints, sequentially connecting all coordinate positions in the coordinate position combination according to a capturing time to generate a limb motion trajectory;
calculating an action matching degree between the limb motion trajectory and a preset standard action trajectory; and
determining the action matching degree as the ball hitting action parameters of the ball hitting person.

18. A tennis training simulation apparatus, comprising:
an acquisition module, configured to acquire ball hitting parameters in a real court through a racket, and acquire ball hitting images in the real court, wherein the tennis training apparatus according to claim 1 is deployed in the real court;
a first calculation module, configured to calculate first trajectory parameters of a first motion trajectory of a target tennis ball in the real court according to the ball hitting parameters and the ball hitting images;
a second calculation module, configured to calculate second trajectory parameters of the target tennis ball in a virtual court based on the first trajectory parameters, wherein a court of the target tennis ball comprises the real court and the virtual court; and
a rendering module, configured to render, by using the second trajectory parameters, a second motion trajectory of the target tennis ball during a motion in the virtual court, wherein a motion trajectory of the target tennis ball comprises the first motion trajectory and the second motion trajectory.

19. An electronic device, comprising a processor, a communications interface, a memory and a communications bus, wherein the processor, the communications interface and the memory communicate with each other through the communications bus; wherein
the memory is configured to store a computer program; and
the processor is configured to implement steps of the tennis training simulation method according to claim 12 by executing the computer program stored in the memory.

20. A storage medium, comprising a stored program, wherein the stored program, when executed, implements steps of the tennis training simulation method according to claim 12.
